(19) United States
(12) Patent Application Publication
(10) Pub. No.: US 2009/0303334 A1
(43) Pub. Date: Dec. 10, 2009

(54) CROWD PHOTOGRAPHY

(76) Inventor: Conrad D'Auvergne Botha, Johannesburg (ZA)

Correspondence Address: SUGHRUE MION, PLLC, 2100 PENNSYLVANIA AVENUE, N.W., SUITE 800, WASHINGTON, DC, 20037, US

(21) Appl. No.: 12/377,050

(22) PCT Filed: Aug. 10, 2007
(86) PCT No.: PCT/IB2007/053190

§ 371 Date: Apr. 21, 2009

(30) Foreign Application Priority Data
Aug. 10, 2006 (ZA) 2006/06650

(51) Int. Cl. H04N 5/225

(52) U.S. Cl. 348/218.1; 348/E05.024

(57) ABSTRACT

The invention provides for an apparatus (10) for photographing one or more members of a crowd at a crowd scene such as a sports or entertainment venue. The apparatus (10) includes a camera (12), a rail (18) on which the camera (12) is mounted and along which it is movable, a drive motor (22) for moving the camera (12) along the rail (18) and a control means for controlling movement of the camera (12) along the rail (18) and operation of the camera (12) such as the degree of tilt and focus of the camera (12). The movement and operation of the camera (12) can be controlled wirelessly from a remote location or can be controlled by means of a programmed processing unit (26). The invention extends to a method of photographing members of a crowd and to an installation which includes the apparatus (10).

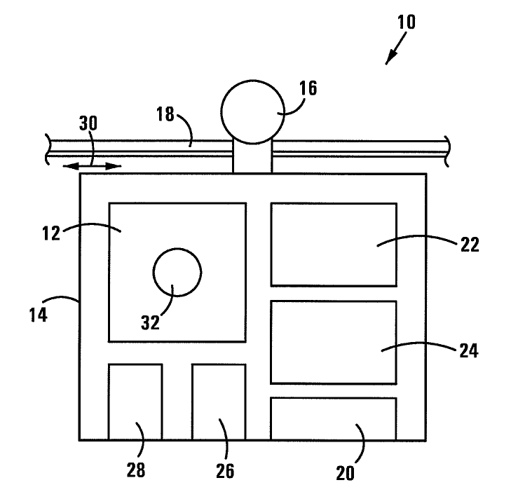

This invention relates, broadly, to crowd photography. More particularly, the invention relates to a method and an apparatus or installation for photographing a crowd and/or members thereof, at a crowd scene for example at a sports or entertainment venue.

According to one aspect of the invention there is provided a method of photographing one or more members of a crowd at a crowd scene, the method comprising the steps of:

moving a camera along a predetermined path provided at the crowd scene; and

taking a plurality of photographs of the crowd scene from a plurality of places on the path by means of the camera.

Each photograph may be of one or more persons forming part of the crowd.

The path may be a track.

The method may include controlling movement and operation of the camera from a remote location in a wireless manner, for example by means of a remote controller whereby a radio signal or other electromagnetic signal is used. Instead, movement and operation of the camera may be controlled by a local, electronic processing unit. The method may further include operating a drive motor associated with the camera, to move the camera along the track.

Moving the camera may be along a track provided by at least one rail, along which the camera is rolled by means of one or more wheels which may be associated with a drive motor operatively connected to the processing unit and to at least one said wheel.

The method may include operating various components to operate the camera in a desired manner. More particularly, the method may include operating an operating component, to cause the camera to take photographs of persons in the crowd. The method may further include operating an operating component to cause the camera to pivot about at least one axis, to tilt the camera to point its lens in a desired direction and may include operating an operating component to cause the camera to zoom and focus on different persons in the crowd.

For example, operating the camera may be by means of a pivot motor, also operatively associated with the processing unit, for causing the camera to pivot about one or more axes, which may have horizontal and vertical components, to tilt the camera as desired to point its lens in desired directions. Other motors may be used to zoom and focus as desired, on different persons in the crowd.

Other operating components may include a camera shutter or a functional equivalent of a shutter, a zooming component which may form part of the camera and a receiver for receiving an electromagnetic signal from a remote controller.

The drive motor and the pivot motor may be electrically-driven, the method including supplying electrical power thereto by means of a battery of electrochemical power storage cells associated with the camera and movable therewith along the track.

According to another aspect of the invention there is provided an apparatus for photographing one or more members of a crowd at a crowd scene, which includes:

a camera;

a path defining means for defining a predetermined path along which the camera is movable;

a drive motor connected to the camera for moving the camera along the path; and

a control means for controlling operation of the drive motor and of the camera.

The path may be a track.

The control means may be associated with the camera and be movable with the camera along the path. The control means may include a local electronic processing unit. Instead, the control means may include a remote controller which generates an electromagnetic signal which is transmitted and a local receiver for receiving the signal.

The apparatus may include various operating components for operating the camera and which are responsive to the processing unit or to a signal transmitted from the remote controller and received by the receiver, as the case may be. The operating components may include a pivot motor for causing the camera to pivot about at least one axis, to tilt the camera to point its lens in a desired direction. Further motors may be provided to operate a camera shutter or a functional equivalent of a shutter and to zoom in and out.

The apparatus may include hardware and software for automatic control of the movement and/or operation of the camera Thus, the processing unit may be programmable. In particular, the processing unit may be programmed to control operation of the drive motor and operation of the camera.

The track may comprise at least one rail on which the camera is mounted via at least one wheel which engages the track to roll along it. The camera may be mounted in a housing which is in turn is movable along the path. More particularly, the housing may be mounted via the wheel on the rail. The housing may be weather-resistant.

The apparatus may include an electrical power supply which may conveniently be located in the housing. The electrical power supply may be in the form of a battery of electrochemical storage cells. The apparatus may also include a memory device such as a hard drive which may be associated with the processing unit. The processing unit and the operating components may be located within the housing. Thus, in this set-up, the motors may be electrically-driven by the battery, together with the processing unit and hard drive, so that the camera can be electrically moved along the track and operated, as desired, from a remote location or automatically.

The invention extends to an installation which includes an apparatus as described above. The installation may be permanent, the apparatus and its track being permanently installed at a venue, for example a sports or entertainment venue, for photographing members of a crowd such as spectators or members of an audience.

The invention will now be described, by way of non-limiting illustrative examples, with reference to the accompanying diagrammatic drawing, in which the single FIGURE shows a schematic view of an apparatus in accordance with the invention, in more or less block-diagram format.

In the drawing, reference numeral 10 generally designates an apparatus according to the invention. The apparatus 10 comprises a camera, in this example a digital, still camera 12, mounted in a weather-resistant housing 14 slung via a wheel 16 from an elevated rail 18. In housing 14, together with the camera 12, are located an electrochemical power storage battery 20, an electric drive motor 22, a processing unit 26, a hard drive 28 and various operating components including a pivot motor 24.

The drive motor 22 is operatively connected by a mechanical drive (not shown) to the wheel 16 and is arranged to drive it in opposite directions in the direction of arrow 30 from place to place along the rail 18, as desired. The motor 22 is electrically driven by the battery 20, to which it is electrically connected. The apparatus 10 has various operating components including a pivot motor 24, a camera shutter (not shown) and a zooming component (not shown) which forms part of the camera 12. The apparatus also includes a receiver (not shown) located within the housing 14 for receiving an electromagnetic signal transmitted from a remote controller (not shown). The pivot motor 24 is powered by the battery 20 and is operatively connected to the camera 12 which is tiltably mounted in the housing 14 about suitable axes which permit the direction in which its lens 32 points to be tilted up-and-down and from side-to-side about said axes, by means of the pivot motor 24.

In turn, the processing unit 26 and hard drive 28 are electrically connected together and powered by the battery 20, and are connected to the motor 22, to the pivot motor 24, to the receiver and to the camera 12, for controlling operation thereof, in this example in a wireless manner such as by means of a radio or other suitable electromagnetic signal generated and transmitted from a remote location, the operating components being responsive to a signal transmitted by the remote controller and received by the receiver.

In use, signals from the remote controller at the remote location are used to move the housing 14 and its contents by means of the receiver, the motor 22 and the wheel 16 from place to place along the rail 18 at the crowd venue where the rail 18 is located. At these places the remote controller is used, via the receiver and the operating components, the processing unit 26 and the hard drive 28, to control operation of the camera 12. This control is by tilting the camera 12 by operation of the pivot motor 24 so that its lens 32 points in desired directions at the crowd, to photograph one or more crowd members by operation of the shutter, while zooming the camera 12 by operation of the camera's zooming component, as desired, to alter the degree of magnification.

In this regard the camera 12, processing unit 26 and drive 28 may be arranged and constructed to enable remote monitoring of where the lens 32 is pointed and monitoring of the degree of magnification achieved by the zoom. This allows the camera 12 to be pointed more or less in an exactly desired direction and with a more or less exactly desired degree of magnification. In this way crowds can be monitored and members thereof can be photographed and identified later. The photographs are stored on the hard drive 28 and downloaded at a later stage.

Naturally, instead of wireless control from a remote location, the processing unit 26 and/or hard drive 28 may be pre-programmed so that the camera moves automatically from place to place along the rail, and automatically takes photographs of different persons forming part of the crowd. It will be appreciated that the apparatus 10 will typically be provided with suitable software to achieve this.

In each case, the processing unit 26 and/or hard drive 28 may be connected to a transmission device, for transmitting the photographs electronically and digitally, for example in wireless fashion, to a remote location where the photographed images can be stored in digital form, and printed when desired.

In a development of the invention, persons occupying particular seats at the venue can be photographed, and their photographs can be made available, for example on the Internet at a web site, identified by the seat number and the date, so that interested persons may be able to obtain photographs of themselves at that venue and on that date.

1. A method of photographing one or more members of a crowd at a crowd scene, the method comprising the steps of:
moving a camera along a predetermined path provided at the crowd scene; and
taking a plurality of photographs of the crowd scene from a plurality of places on the path by means of the camera.

2. A method as claimed in claim 1, wherein the predetermined path is a track.

3. A method as claimed in claim 1, further comprising the step of controlling movement and operation of the camera from a remote location in a wireless manner.

4. A method as claimed in claim 1, further comprising the step of controlling movement and operation of the camera by a local electronic processing unit.

5. A method as claimed in any one of claim 1, further comprising the step of operating various operating components to operate the camera in a desired manner.

6. An apparatus for photographing one or more members of a crowd at a crowd scene, which includes:
a camera;
a path defining means for defining a predetermined path along which the camera is movable;
a drive motor connected to the camera for moving the camera along the path; and
a control means for controlling operation of the drive motor and the camera.

7. An apparatus as claimed in claim 6, wherein the path is a track.

8. An apparatus as claimed in claim 6, wherein the control means is associated with the camera and is movable with the camera along the path.

9. An apparatus as claimed in claim 8, wherein the control means includes a local electronic processing unit.

10. An apparatus as claimed in claim 9, further comprising operating components for operating the camera which are responsive to the processing unit.

11. An apparatus as claimed in claim 9, wherein the processing unit is programmable.

12. An apparatus as claimed in claim 6, wherein the control means includes a remote controller which generates an electromagnetic signal which is transmitted and a local receiver for receiving the signal.

13. An apparatus as claimed in claim 12, further comprising operating components for operating the camera which are responsive to a signal transmitted from the remote controller and received by the receiver.

14. An apparatus as claimed in claim 7, wherein the track comprises at least one rail on which the camera is mounted via at least one wheel which engages the track to roll along it.

15. An apparatus as claimed in claim 6, wherein the camera is mounted in a housing which is in turn movable along the path.

16. An apparatus as claimed in claim 15, wherein the housing is weather-resistant.

17. An apparatus as claimed in claim 15, further comprising an electrical power supply located in the housing.

18. An apparatus as claimed in claim 10, wherein one of the operating components is a pivot motor for causing the camera to pivot about at least one axis, to tilt the camera to point its lens in a desired direction.

19. An installation which includes an apparatus as claimed in claim 6.

20-22. (canceled)
